(19) United States
(12) Patent Application Publication
(10) Pub. No.: US 2014/0246810 A1
(43) Pub. Date: Sep. 4, 2014

(54) MOLDING METHOD AND APPARATUS THEREFOR

(71) Applicant: HONDA MOTOR CO., LTD., Tokyo (JP)

(72) Inventors: Hiroshi Kato, Wako-shi (JP); Makoto Nasu, Wako-shi (JP); Masatoshi Kobayashi, Wako-shi (JP); Daiya Yamashita, Wako-shi (JP)

(73) Assignee: HONDA MOTOR CO., LTD., Tokyo (JP)

(21) Appl. No.: 14/192,263

(22) Filed: Feb. 27, 2014

(30) Foreign Application Priority Data
Mar. 1, 2013 (JP) 2013-040888

(51) Int. Cl. B29C 33/12; B29C 67/00; B29C 33/44

(52) U.S. Cl. CPC B29C 33/12; B29C 33/442; B29C 67/0011
USPC 264/325; 425/395

(57) ABSTRACT

In a molding method and an apparatus for the method, a base material is placed on mounting portions of bottom support pins, which protrude from a first inner surface of a lower mold in an open state. Pressing portions of top support pins, which protrude from a second inner surface of an upper mold, are brought into contact with the base material. Consequently, the base material is sandwiched between the mounting portions and the pressing portions. Thereafter, pre-forming preferably is carried out. For example, the bottom support pins and the top support pins are lowered toward the lower mold, such that the base material is brought into contact with the first inner surface. Then, the lower mold and the upper mold are closed, and the base material is molded into a molded article.

### CROSS-REFERENCE TO RELATED APPLICATION

This application is based upon and claims the benefit of priority from Japanese Patent Application No. 2013-040888 filed on Mar. 1, 2013, the contents of which are incorporated herein by reference.

### BACKGROUND OF THE INVENTION

1. Field of the Invention

The present invention relates to a method and an apparatus for closing lower and upper molds to produce a molded article made from a thermoplastic resin.

2. Description of the Related Art

In a known molding method, a sheet-shaped base material containing a thermoplastic resin is shaped in a cavity formed between lower and upper molds in order to produce a molded article. In this method, in general, the base material is heated to a temperature that is equal to or greater than the melting temperature of the thermoplastic resin, the heated material is placed on a cavity-forming surface of the lower mold (hereinafter referred to as the inner surface), and then the lower and upper molds are closed.

In the placement step, the temperature of the lower mold is kept lower than that of the base material, so that heat from the base material is drawn by the lower mold. Thus, the temperature of the base material is lowered. However, if the temperature of the base material is excessively lowered, the viscosity of the base material is increased, and the base material cannot flow sufficiently into the cavity. In this case, the cavity cannot be filled sufficiently with the base material, and a suitable molded article cannot be produced with satisfactory dimensional accuracy.

In view of preventing heat transfer from the base material to the lower mold before the molding step, Japanese Laid-Open Patent Publication No. 08-001698 proposes a molding method. In a molding apparatus, which is used in this method, the lower mold has a plurality of support pins that can be moved forward closer to and backward away from the upper mold.

More specifically, at first, the support pins are moved forward, whereby end surfaces of the support pins protrude from the inner surface of the lower mold, and the heated base material is placed on the end surfaces. Then, the support pins are moved backward while the upper mold is lowered toward the lower mold. Immediately before the inner surface of the upper mold comes into contact with the base material, the support pins are retracted into the lower mold, and the lower and upper molds are closed to produce the molded article. Thus, until just prior to closing, the unshaped base material is in contact only with the end surfaces of the support pins. Therefore, pre-molding heat transfer from the base material can be reduced according to this method, as compared with a case in which the base material is placed directly on the inner surface of the lower mold prior to closing the upper and lower molds.

### SUMMARY OF THE INVENTION

In the above molding apparatus, the base material is placed on end surfaces of the support pins without a retainer. Therefore, the base material may become displaced during lowering of the support pins. Thus, the base material may not be located in a correct position on the inner surface of the lower mold.

Furthermore, in the case that the base material is placed on the end surfaces of the support pins without any retainer, since the base material becomes softened due to heating, portions of the base material (portions not in contact with end surfaces of the support pins, i.e., portions between the support pins) may flow downward under the force of gravity prior to completion of the closing step, thus deforming the base material.

In any event, the molded article cannot be produced with satisfactory dimensional accuracy.

A principal object of the present invention is to provide a molding method, which is capable of reducing heat transfer from an unshaped base material to a mold, and which enables a cavity to be sufficiently filled with the base material.

Another object of the present invention is to provide a molding method, which is capable of easily and adequately improving dimensional accuracy of a molded article.

A further object of the present invention is to provide an apparatus for forming a molded article using the above molding method.

According to an aspect of the present invention, there is provided a method for molding a sheet-shaped base material containing a thermoplastic resin into a molded article in a cavity of a molding apparatus. The molding apparatus contains a lower mold and an upper mold, the lower mold has a plurality of bottom support pins that can be moved forward closer to and backward away from the upper mold, and the upper mold has a plurality of top support pins that can be moved forward closer to and backward away from the lower mold.

More specifically, the method comprises the steps of:

moving the bottom support pins forward from the lower mold closer to the upper mold in an open state, so that first end surfaces of the bottom support pins protrude from a first inner surface of the lower mold for forming the cavity;

placing the base material on the first end surfaces, wherein the base material is heated beforehand;

moving the top support pins forward from the upper mold closer to the lower mold, so that second end surfaces of the top support pins protrude from a second inner surface of the upper mold for forming the cavity, thereby sandwiching the base material between the first and second end surfaces; and

closing the lower and upper molds to form the cavity, thereby molding the base material into the molded article.

Since the heated base material is placed on the first end surfaces that protrude from the first inner surface, transfer of heat from the base material prior to molding can be reduced according to this method, as compared with the case in which the base material is placed directly on the first inner surface. Furthermore, when the top support pins are moved toward the base material, which is placed on the first end surfaces, the base material is sandwiched between the first and second end surfaces, so that a tensile force acts on the base material. Therefore, displacement of the base material can be prevented.

Consequently, the shape of the base material is maintained when the bottom support pins and the top support pins are moved forward or backward. Thus, the base material can be brought into contact with the first or second inner surface in the desired correct position.

In addition, since the tensile force acts on the base material, in the base material, portions between the bottom support pins can be prevented from flowing downward. In other words, deformation of the base material can be prevented.

For the above reasons, the molded article can be produced with excellent dimensional accuracy and without defects.

A pre-forming step preferably is carried out prior to molding. Thus, preferably, the method further comprises the step of moving the bottom support pins or the top support pins forward, and moving the other support pins backward, so as to align the first or second end surfaces with the first or second inner surface, thereby pre-forming the base material along the first or second inner surface.

In this case, since molding is performed after the pre-forming step, the forming rate can be reduced during molding. Therefore, even when heat from the pre-formed material is drawn by the mold to some extent, the thermoplastic resin can flow over the entire cavity.

The method preferably further comprises the step of moving at least part of the bottom support pins forward so that the first end surface thereof protrudes from the first inner surface, thereby pushing out and releasing the molded article from the lower mold. Thus, the molded article can easily be released from the molds by using at least one bottom support pin as an ejector pin.

According to another aspect of the present invention, there is provided a molding apparatus comprising a lower mold and an upper mold, for molding a sheet-shaped base material containing a thermoplastic resin into a molded article in a cavity between the lower and upper molds.

The lower mold has a plurality of bottom support pins that can be moved forward closer to and backward away from the upper mold.

The upper mold has a plurality of top support pins that can be moved forward closer to and backward away from the lower mold.

The bottom support pins have first end surfaces, and the base material is placed on the first end surfaces, such that when the bottom support pins are moved completely backward, the first end surfaces form the cavity in combination with a first inner surface of the lower mold.

The top support pins have second end surfaces, and the base material is sandwiched between the first and second end surfaces, such that when the top support pins are moved completely backward, the second end surfaces form the cavity in combination with a second inner surface of the upper mold.

Prior to closing the lower and upper molds, the bottom support pins and the top support pins are moved forward such that the first and second end surfaces thereof protrude from the first and second inner surfaces, whereby the base material is sandwiched between the first and second end surfaces, and then the base material in the sandwiched state is moved backward or forward to a position of the first or second inner surface.

In this structure, the base material can be placed on the first end surfaces, which protrude from the first inner surface, and can be sandwiched between the first and second end surfaces. Therefore, displacement of the base material can be prevented, and the base material can be brought into contact with the first or second inner surface in a desired correct position by moving the bottom support pins and the top support pins forward or backward. Furthermore, when the base material is sandwiched in the above manner, a tensile force acts on the base material. Therefore, in the base material, portions between the bottom support pins can be prevented from flowing downward. Thus, deformation of the base material due to flowing thereof can be prevented.

Consequently, the base material can be molded into a predetermined shape, and the molded article can be produced with excellent dimensional accuracy and without defects.

It is preferred that the bottom support pins also act as ejector pins. In this case, the apparatus can have a simple structure, and the molded article can easily be released from the molds.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic vertical cross-sectional view of a principal part of a molding apparatus according to an embodiment of the present invention;

FIG. 2 is a schematic vertical cross-sectional view of a base material, which is placed on first end surfaces of bottom support pins in the molding apparatus of FIG. 1;

FIG. 3 is a schematic vertical cross-sectional view of the base material, which is sandwiched between the first end surfaces and second end surfaces of the support pins after completion of the step shown in FIG. 2;

FIG. 4 is a schematic vertical cross-sectional view of the base material, which is pre-formed on a first inner surface of a lower mold after completion of the step shown in FIG. 3;

FIG. 5 is a schematic vertical cross-sectional view of the base material, which is molded in a closed state after completion of the step shown in FIG. 4; and

FIG. 6 is a schematic vertical cross-sectional view of a molded article made from the base material, which is released from the mold after completion of the step shown in FIG. 5.

### DESCRIPTION OF THE PREFERRED EMBODIMENTS

A preferred embodiment of the molding method of the present invention, which makes use of the molding apparatus of the present invention, will be described in detail below with reference to the accompanying drawings.

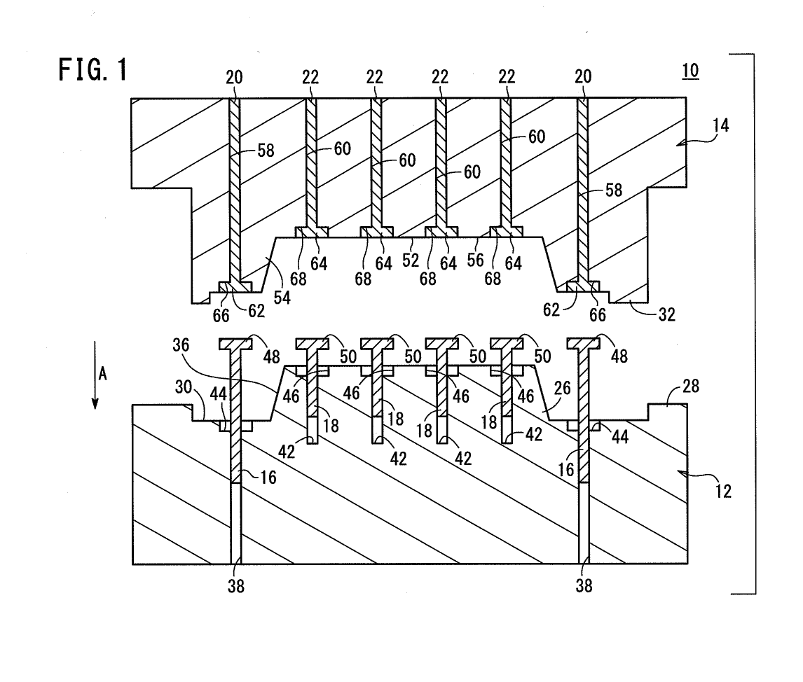

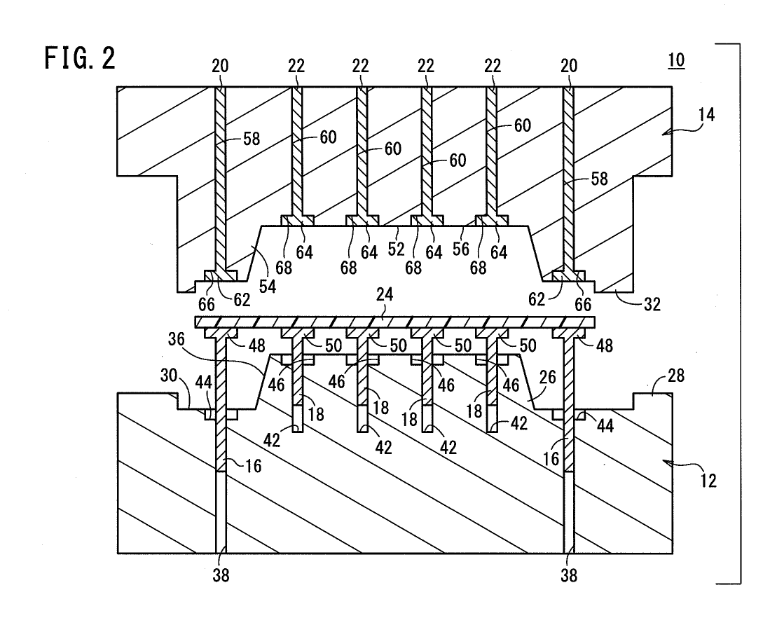

FIG. 1 is a schematic vertical cross-sectional view of a principal part of a molding apparatus 10 according to the present embodiment. The molding apparatus 10 contains a lower mold 12, an upper mold 14 that can be moved closer to and away from the lower mold 12, a plurality of ejector pins 16 and first support pins 18 (bottom support pins), which are disposed in the lower mold 12, and a plurality of second support pins 20 and third support pins 22 (top support pins), which are disposed in the upper mold 14. The molding apparatus 10 is used for molding a base material 24, as shown in FIG. 2.

The base material 24 will briefly be described below. For example, the base material 24 is a quadrangular sheet containing at least a thermoplastic resin. The base material 24 may be composed of only the thermoplastic resin, or a fiber-reinforced composite containing the thermoplastic resin and a reinforcing substance such as glass fibers or carbon fibers (e.g. CFRTP).

The structure of the molding apparatus 10 will be described in detail below. The lower mold 12 is a stationary mold, which is fixed in a predetermined position. The lower mold 12 is a so-called male mold having a tapered first protrusion 26 extending toward the upper mold 14. A ring-shaped protrusion 28 extends toward the upper mold 14 on the peripheral edge of the lower mold 12. Therefore, a relatively depressed, ring-shaped first depression 30 is formed around the first protrusion 26.

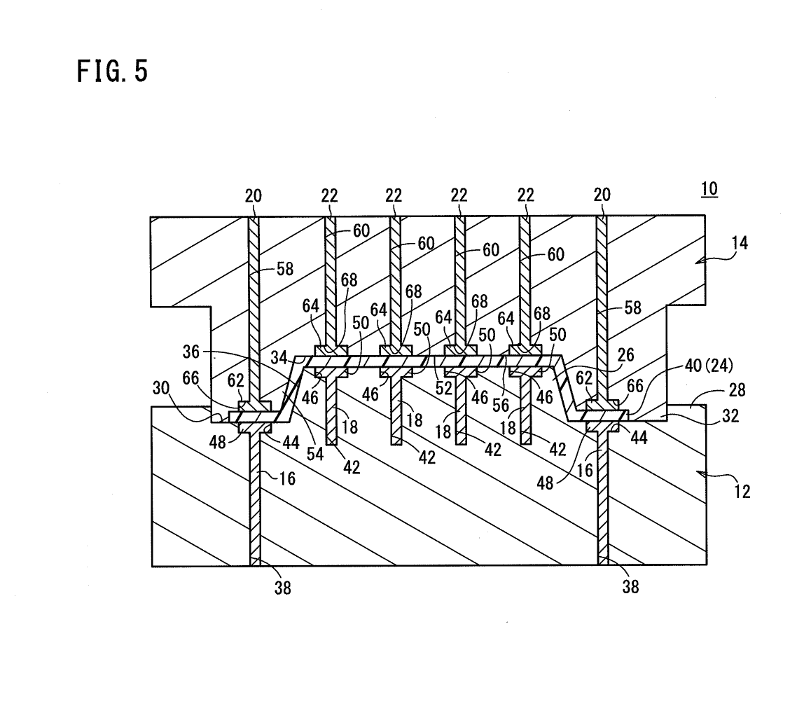

In this case, a ring-shaped lower end 32 of the upper mold 14 is placed on the first depression 30 around the first protrusion 26. A cavity 34 (see FIG. 5) is formed by surfaces of the first depression 30 and the first protrusion 26 (i.e., surfaces facing the upper mold 14) inside of the portion on which the lower end 32 is placed. The surfaces that form the cavity 34 will hereinafter be referred to as a first inner surface 36.

A plurality of first container holes 38 are formed in the first depression 30 (see FIG. 1), and the ejector pins 16 are placed in the first container holes 38. Only two ejector pins 16 are shown in FIG. 1.

All of the ejector pins 16 can be lowered and raised synchronously by a first drive (not shown). As described hereinafter, a molded article 40 (see FIG. 5) can be released by raising the ejector pins 16.

A plurality of second container holes 42 are formed in the first protrusion 26 (see FIG. 1), and the first support pins 18 are placed in the second container holes 42. Only four first support pins 18 are shown in FIG. 1.

Each of the first container holes 38 and the second container holes 42 includes a stepped portion 44, 46 into which a head is placed, as described hereinafter. A coil spring (not shown) is disposed in the second container hole 42. A spring force for pressing the first support pin 18 toward the upper mold 14 is constantly applied by the coil spring. Therefore, when a load is not applied to the first support pin 18, the first support pin 18 is moved forwardly away from the lower mold 12 (i.e., closer to the upper mold 14), whereupon the first support pin 18 protrudes from the second container hole 42.

When the first support pin 18 is pressed by the third support pin 22, the coil spring is compressed. Therefore, the first support pin 18 is moved backward closer to the lower mold 12 (away from the upper mold 14) and is placed in the second container hole 42. Thus, the first support pin 18 is capable of moving forward closer to and backward away from the upper mold 14. In other words, the first support pin 18 can be moved in the direction of the arrow A in the second container hole 42.

Each of the ejector pins 16 and the first support pins 18 includes a head and a shank. The diameter of the head is greater than the diameter of the shank. The head acts as a mounting portion 48, 50 on which the base material 24 is placed. When the ejector pins 16 and the first support pins 18 are moved backward completely (i.e., when the ejector pins 16 and the first support pins 18 are placed in the first container holes 38 and the second container holes 42), the upper surfaces (first end surfaces) of the mounting portions 48 of the ejector pins 16 are placed in the stepped portions 44 and become aligned with the first inner surface 36 (the bottom surface of the first depression 30), and the upper surfaces (first end surfaces) of the mounting portions 50 of the first support pins 18 are placed in the stepped portions 46 and become aligned with the first inner surface 36 (the top surface of the first protrusion 26). Thus, the upper surfaces of the mounting portions 48, 50 act in combination with the first inner surface 36 to form the cavity 34.

The upper mold 14 can be lowered and raised (can be moved forward closer to and backward away from the lower mold 12) by an elevating mechanism (not shown). Thus, the upper mold 14 can also be moved in the direction of the arrow A shown in FIG. 1.

The upper mold 14 is a so-called female mold having a second depression 52 into which the first protrusion 26 of the lower mold 12 is inserted. A relatively protruded, ring-shaped second protrusion 54 is formed around the second depression 52 and extends toward the first depression 30. The ring-shaped lower end 32 extends further toward the lower mold 12 from the peripheral edge of the second protrusion 54.

The cavity 34 (see FIG. 5) is formed by surfaces of the second depression 52 and the second protrusion 54 (i.e., surfaces thereof that face toward the lower mold 12) and the first inner surface 36. Such surfaces will hereinafter be referred to as a second inner surface 56. Incidentally, when the upper mold 14 is closed, the ring-shaped lower end 32 is positioned on the peripheral edge of the first depression 30 in the lower mold 12.

A plurality of third container holes 58 and a plurality of fourth container holes 60 are formed on the second protrusion 54 and on the second depression 52, respectively (see FIG. 1). The second support pins 20 are placed in the third container holes 58, and the third support pins 22 are placed in the fourth container holes 60. Only two third container holes 58, two second support pins 20, four fourth container holes 60, and four third support pins 22 are shown in FIG. 1. Further, as shown in FIG. 1, the length of the second support pins 20 is greater than the length of the third support pins 22 in the longitudinal (vertical) direction.

All of the second support pins 20 can be lowered and raised synchronously by a second drive (not shown). Similarly, all of the third support pins 22 can be lowered and raised synchronously by a third drive (not shown). Thus, the second support pins 20 and the third support pins 22 can be lowered and raised (can be moved forward closer to and backward away from the lower mold 12).

Each of the second support pins 20 and the third support pins 22 has a head and a shank, with the diameter of the head being greater than the diameter of the shank. The head acts as a pressing portion 62, 64 for pressing the base material 24, which is placed on the mounting portions 48, 50. The second support pins 20 are arranged in confronting relation to the ejector pins 16, and the third support pins 22 are arranged in confronting relation to the first support pins 18. Therefore, the base material 24 can be sandwiched between the mounting portions 48, 50 and the pressing portions 62, 64.

Each of the third container holes 58 and the fourth container holes 60 includes a stepped portion 66, 68. When the second support pins 20 and the third support pins 22 are moved backward completely (i.e., when the second support pins 20 and the third support pins 22 are placed respectively in the third container holes 58 and the fourth container holes 60), the lower surfaces (second end surfaces) of the pressing portions 62 of the second support pins 20 are placed in the stepped portions 66 and become aligned with the second inner surface 56 (the lower surface of the second protrusion 54). In addition, the lower surfaces (second end surfaces) of the pressing portions 64 of the third support pins 22 are placed in the stepped portions 68 and become aligned with the second inner surface 56 (the ceiling surface of the second depression 52). Thus, the lower surfaces of the pressing portions 62, 64 act in combination with the second inner surface 56 to form the cavity 34.

The molding apparatus 10 according to the present embodiment is basically constructed as described above. Operations and advantages of the molding apparatus 10 will be described below in relation to a molding method according to another aspect of the present invention.

As shown in FIG. 1, when the molding apparatus 10 is in an open state, spring forces are applied to the first support pins 18 by the coil springs, whereby the first support pins 18 are moved forward away from the lower mold 12 and protrude from the first inner surface 36 (the top surface of the first protrusion 26). Then, the ejector pins 16 are raised (moved forward) synchronously away from the lower mold 12 by the first drive, and the ejector pins 16 protrude from the first inner surface 36 (the bottom surface of the first depression 30). The mounting portions 48 of the ejector pins 16 are raised and aligned with the mounting portions 50 of the first support pins 18, which have moved away from the lower mold 12. Although in this embodiment, as shown in FIG. 1, the mounting portions 48 of the ejector pins 16 are located at the same level as the mounting portions 50 of the first support pins 18, the mounting portions 48, 50 may be located at different levels depending on the shape of the molded article.

As shown in FIG. 2, the base material 24 is placed on the mounting portions 48, 50. It should be noted that the base material 24 is heated beforehand to a temperature that is equal to or higher than the melting temperature of the thermoplastic resin.

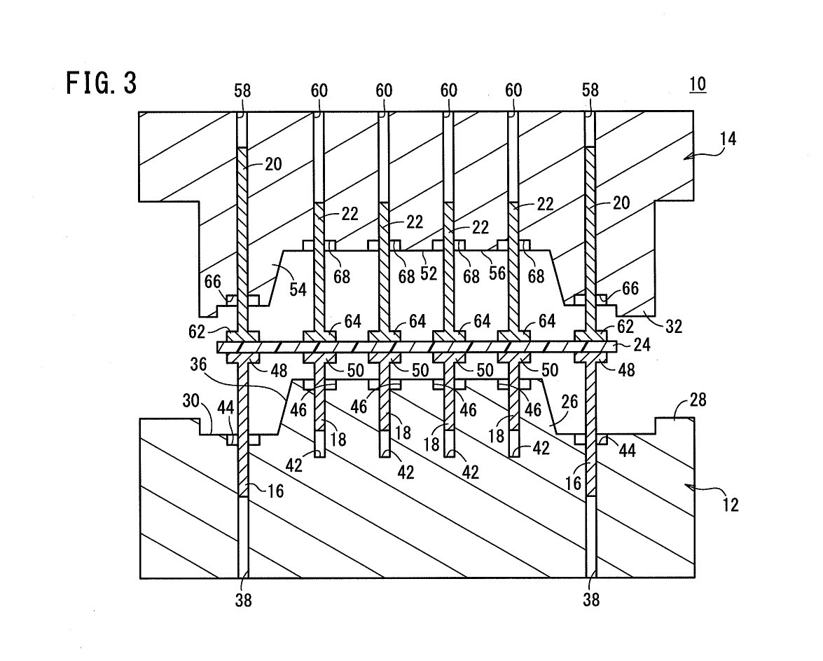

As shown in FIG. 3, the second and third drives are actuated, whereby the second support pins 20 and the third support pins 22 are made to protrude from the second inner surface 56. Thus, the second support pins 20 and the third support pins 22 are lowered (moved forward) closer to the lower mold 12. During the lowering process, the pressing portions 62, 64 of the second support pins 20 and the third support pins 22 are brought into contact with the base material 24.

Preferably, the pressing portions 62, 64 of the second support pins 20 and the third support pins 22 are brought into contact approximately simultaneously with the base material 24. For example, the pressing portions 62, 64 may be brought into contact with the base material 24 approximately simultaneously, in such a manner that the second and third drives are actuated simultaneously, with the second support pins 20 being lowered at a lower speed, and the third support pins 22 being lowered at a higher speed. Alternatively, the pressing portions 62, 64 may be brought into contact with the base material 24 approximately simultaneously, in such a manner that the third drive is actuated, the third support pins 22 are lowered to predetermined positions, and then the second drive is actuated.

In this case, the entire base material 24 is sandwiched between the mounting portions 48, 50 and the pressing portions 62, 64 while a tensile force acts on the base material. Consequently, the base material 24 can be prevented from flowing downward between the ejector pins 16 and the first support pins 18, or between the first support pins 18. Furthermore, the position of the base material 24 can be maintained in a stable manner by sandwiching the base material 24, such that displacement of the base material 24 can also be prevented.

In addition, during this step, only the small areas of the mounting portions 48, 50 and the pressing portions 62, 64 are kept in contact with the base material 24. Therefore, excessive heat transfer from the base material 24 can be prevented.

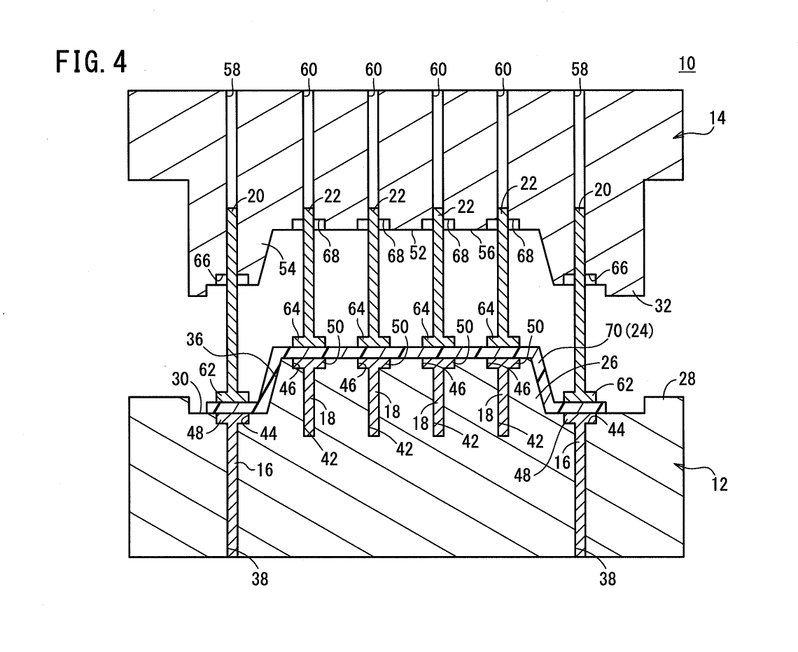

Thereafter, as shown in FIG. 4, the second support pins 20 and the third support pins 22 are further moved forward, whereupon the base material 24 is pressed by the pressing portions 62, 64. Consequently, a load (force) is applied to the ejector pins 16 and the first support pins 18, so that the ejector pins 16 and the first support pins 18 are lowered (moved backward) closer to the lower mold 12. During this step, the coil springs are compressed.

When the ejector pins 16 and the first support pins 18 are moved backward completely, the mounting portions 48, 50 are placed in the stepped portions 44, 46 such that the upper surfaces of the mounting portions 48, 50 become aligned with the first inner surface 36. Consequently, the base material 24 is brought into contact with the first inner surface 36 and is formed into a shape that corresponds to the shape of the first depression 30 and the first protrusion 26. Thus, in this step, the base material 24 is pre-formed.

Until the base material 24 has reached the lower mold 12 in the foregoing manner, the entire base material 24 remains sandwiched between the mounting portions 48, 50 and the pressing portions 62, 64, as described above. Therefore, displacement of the base material 24 can be prevented, and the base material 24 can accurately be located in a desired position on the first inner surface 36.

Furthermore, since the base material 24 is brought into contact with the first inner surface 36 in a tensed condition under the tensile force, the base material 24 can be prevented from wrinkling. In addition, heat, which is transferred from the base material 24 to the mounting portions 48, 50 and the pressing portions 62, 64, can be reduced. Consequently, flowing of the base material 24 can easily take place in order to obtain a pre-formed material 70 with high dimensional accuracy.

Preferably, the molding apparatus 10 is closed immediately after pre-forming of the base material 24 is completed. Thus, the elevating mechanism is actuated, and the upper mold 14 is lowered (moved forward) closer to the lower mold 12. Then, the ring-shaped lower end 32 of the upper mold 14 is placed on the peripheral edge of the first depression 30 in the lower mold 12. The second support pins 20 and the third support pins 22 are stopped by a reactive force of the lower mold 12 and the base material 24, and thereby are raised (moved backward) relatively with respect to the lowered upper mold 14. Consequently, the second support pins 20 and the third support pins 22 are inserted into the third container holes 58 and the fourth container holes 60, the pressing portions 62, 64 are placed in the stepped portions 66, 68, and the lower surfaces of the pressing portions 62, 64 become aligned with the second inner surface 56.

By carrying out the above steps, the cavity 34 is formed, and the pre-formed material 70 (the base material 24) is molded into a shape corresponding to the shape of the cavity 34. The molded article 40 can be produced in this manner.

In the pre-forming step, the base material 24 is sufficiently shaped into the pre-formed material 70. Therefore, the pre-formed material 70 is not shaped at a high forming rate in the molding step. Even when heat from the pre-formed material 70 is drawn by the lower mold 12 to some extent, the entire cavity 34 can be filled satisfactorily with the thermoplastic resin. Consequently, the molded article 40 can be produced with excellent dimensional accuracy.

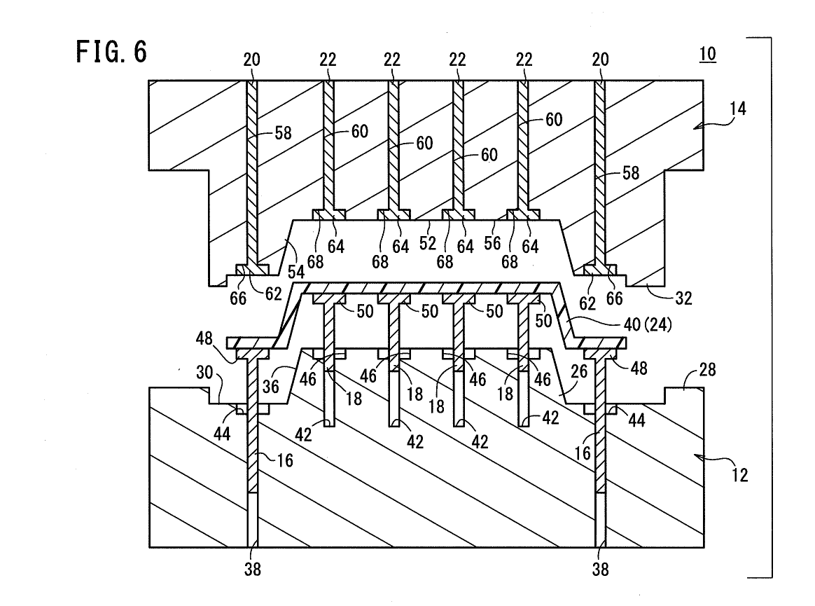

As shown in FIG. 6, after the molded article 40 is cooled and hardened, the upper mold 14 is raised (moved backward) by the elevating mechanism in order to open the molding apparatus 10. Furthermore, the first drive is actuated, whereupon the ejector pins 16 are raised. In this manner, the molded article 40 can be pushed out and released from the lower mold 12. Further, during this step, the first support pins 18 are made to protrude from the first inner surface 36 under the spring forces of the coil springs.

The present invention is not limited to the above embodiment. Various changes and modifications can be made to the embodiment without departing from the scope of the invention.

For example, although in the above embodiment, the ejector pins 16 and the first support pins 18 are lowered (moved backward) closer to the lower mold 12, the ejector pins 16 and the first support pins 18 may be raised (moved forward) closer to the upper mold 14, and the second support pins 20 and the third support pins 22 may be raised (moved backward) closer to the upper mold 14, whereby the base material 24 is brought into contact with the second inner surface 56. In this case, the first support pins 18 may be raised and lowered by a drive similar to the case of the ejector pins 16. Alternatively, coil springs may be used for applying spring forces that bias the second support pins 20 and the third support pins 22 toward the lower mold 12.

Furthermore, although in the above embodiment, the ejector pins 16 act in the same manner as the first support pins 18 (i.e., the ejector pins 16 also are used as bottom support pins), the ejector pins 16 may be used only for releasing the molded article 40 in combination with the first support pins 18 that function as bottom support pins.

Furthermore, the molding step may be performed without the pre-forming step.

While the invention has been particularly shown and described with reference to a preferred embodiment, it will be understood that variations and modifications can be effected thereto by those skilled in the art without departing from the scope of the invention as defined by the appended claims.

What is claimed is:

1. A method for molding a sheet-shaped base material containing a thermoplastic resin into a molded article in a cavity of a molding apparatus, wherein:
the molding apparatus contains a lower mold and an upper mold;
the lower mold has a plurality of bottom support pins that can be moved forward closer to and backward away from the upper mold; and
the upper mold has a plurality of top support pins that can be moved forward closer to and backward away from the lower mold;
the method comprising the steps of:
moving the bottom support pins forward from the lower mold closer to the upper mold in an open state, so that first end surfaces of the bottom support pins protrude from a first inner surface of the lower mold for forming the cavity;
placing the base material on the first end surfaces, wherein the base material is heated beforehand;
moving the top support pins forward from the upper mold closer to the lower mold, so that second end surfaces of the top support pins protrude from a second inner surface of the upper mold for forming the cavity, thereby sandwiching the base material between the first end surfaces and the second end surfaces; and
closing the lower mold and the upper mold to form the cavity, thereby molding the base material into the molded article.

2. The method according to claim 1, further comprising the step of:
prior to molding, moving the bottom support pins or the top support pins forward, and moving the other support pins backward, so as to align the first end surfaces or the second end surfaces with the first inner surface or the second inner surface, thereby pre-forming the base material along the first inner surface or the second inner surface.

3. The method according to claim 1, further comprising the step of:
moving at least part of the bottom support pins forward so that the first end surface thereof protrudes from the first inner surface, thereby pushing out and releasing the molded article from the lower mold.

4. A molding apparatus comprising a lower mold and an upper mold, for molding a sheet-shaped base material containing a thermoplastic resin into a molded article in a cavity between the lower mold and the upper mold, wherein:
the lower mold has a plurality of bottom support pins that can be moved forward closer to and backward away from the upper mold;
the upper mold has a plurality of top support pins that can be moved forward closer to and backward away from the lower mold;
the bottom support pins have first end surfaces, the base material is placed on the first end surfaces, and the first end surfaces form the cavity in combination with a first inner surface of the lower mold when the bottom support pins are moved completely backward;
the top support pins have second end surfaces, the base material is sandwiched between the first end surfaces and the second end surfaces, and the second end surfaces form the cavity in combination with a second inner surface of the upper mold when the top support pins are moved completely backward; and
prior to closing the lower mold and the upper mold, the bottom support pins and the top support pins are moved forward such that the first end surfaces and the second end surfaces protrude from the first inner surface and the second inner surface, whereby the base material is sandwiched between the first end surfaces and the second end surfaces, and then the base material in the sandwiched state is moved backward or forward to a position of the first inner surface or the second inner surface.

5. The molding apparatus according to claim 4, wherein at least part of the bottom support pins acts as an ejector pin.
